(19) United States
(12) Patent Application Publication
(10) Pub. No.: US 2011/0069497 A1
(43) Pub. Date: Mar. 24, 2011

(54) GLASS BODIES WITH ADDITIONALLY FORMED INNER FACE FOR PRODUCING LIGHT EFFECTS

(76) Inventor: Richard Gareis, Tegemheim (DE)

(21) Appl. No.: 12/888,250

(22) Filed: Sep. 22, 2010

(30) Foreign Application Priority Data
Sep. 23, 2009 (DE) 10 2009 042 358.3

(51) Int. Cl. F21V 3/00; C03B 23/00; C03B 23/045; C03C 15/00

(52) U.S. Cl. 362/311.13; 65/108; 65/105; 428/34.4

(57) ABSTRACT

The invention relates to production methods for producing a transparent body which is textured at least on the inside, [which] comprises the steps of producing the glass body (1) in order to prepare a blank (2) to be further treated, of producing a first defined texture (4) of an interior space (6) of the glass body (1) in order to form a treatment area (8) and of treating the treatment area (8) in order to enlarge the interior space (6) of the glass body (1). According to the invention the treatment of the treatment area (8) results in a second texture (10) formed in a random manner at least in part.

The present invention relates to a method of producing transparent glass bodies, which are textured at least on the inside and preferably made solid, according to the preamble of claim 1, a glass body of this type according to the preamble of claim 12 and a lighting apparatus for producing light effects according to the preamble of claim 13.

There is an extensive market for top quality decorative items which create a top quality impression in both tactile and visual terms and which on account of a large number of different details and variations encourage the observer or the possessor to examine it. It is evident from the example of lava lamps that decorative items of this type can likewise be used for the illumination of rooms. Lava lamps have the drawback, however, that they contain liquids which make it necessary for complicated seals to be provided and which require a certain heating phase until the desired effect takes place.

The object of the present invention is therefore to provide a production method, a glass body and a lighting apparatus which make it possible to generate interesting lighting effects for the observer in a simple manner, without a heating phase or complicated sealing devices having to be provided.

A production method according to the invention for producing a transparent body which is textured at least on the inside comprises the steps of producing a glass body in order to prepare a blank to be further treated, of producing a first defined texture of an interior space of the glass body in order to form a treatment area and of treating the treatment area in order to enlarge the interior space of the glass body. In this case the production of the glass body is carried out by supplying liquid glass to a mould and the subsequent solidification of the glass. The liquid glass poured in preferably encloses a tool during the production of the glass body, and it is likewise possible for the tool to be introduced into a container with liquid glass. In this way, the positive texture of the tool becomes the first, formed internal texture of the glass body by the solidification of the glass. The tool can be removed out of the glass after a suitable drop in temperature for example, in which case the glass can still have a ductile state and is then preferably tempered in order to obtain a stress-free state. According to the invention the treatment of the treatment area results in a second texture formed at random at least in part. In this context “transparent” is to be understood as meaning transparent at least in part and preferably fully transparent. Glass bodies of this type preferably have a facet cut.

On the inside the glass bodies have a crystal-like texture which depending upon their design can be pyramidal—straight upwards, converging to a tip or slightly radial—rounded upwards. The number of faces of the pyramidal texture preferably amounts to 3, 4, 5, 6, 7 or 8 faces, and additional faces would likewise be possible. After the treatment of the pyramidal internal texture of the glass body the latter has a plurality, preferably hundreds and particularly preferably thousands, of ultra-smooth reflective faces which are shaped like a conchoidal fracture and which give a highly aesthetic and brilliant impression. A single- or multiple-colour emission of light can be achieved on the solid glass body with the light energy supplied by light conduction by way of light guide strips.

It is further possible that the glass bodies are not fully made of glass, they can also contain plastics respectively synthetic material. The glass bodies preferably contain an amount of 30-80 percent plastic or synthetic material but it is also possible that the glass bodies are fully made of plastic or synthetic material, thus the glass bodies can be also be termed plastic or synthetic material bodies.

It is likewise possible for example for precious metals such as gold or silver or precious stones or other materials such as for example wood, bronze, galvanized brass, leather or their combination to be arranged on the glass body, for further visual enhancement.

In a further preferred embodiment of the present invention the glass body encloses a tool at least in part during the production of the glass body. This means that a tool is provided at least in part inside the casting mould or is capable of being inserted into the casting mould into which the liquid glass is introduced and thus the texture of the tool becomes the internal texture of the glass body or an anti-crystal. In this case the tool is preferably a pressing tool of highly heat-resistant material (for example Sicromal V4A or the like).

In a further preferred embodiment of the present invention the tool has a defined shape by which the material in a contact region forms the first texture which substantially corresponds to the shape of the tool. As described above, the liquid glass encloses the tool at least in part, as a result of which the shape of the tool is transferred to the glass body or the internal texture thereof as the liquid glass cools. In this case it is additionally possible for a further layer, a foil and/or a further body to be interposed between the tool and the liquid glass.

In a further preferred embodiment of the present invention the first texture is formed in such a way that it is largest in surface area in the plane of an outer edge of the glass body and is orientated in its extension direction in an angular range of less than or equal to 90° with respect to the plane. This means that the interior space bounded by the first texture extends reduced in the width thereof at least in part from the aforementioned plane into the main body or into the glass body respectively. This has the advantage that undercuts are avoided and, after the production of the glass body or the cooling of the glass, the tool producing the interior space is capable of being removed from the region of the glass body. In this case the first texture is preferably made step-shaped at least in part and/or is preferably made spiral-shaped at least in part. The tool in this case is essentially comparable with a mould core which is preferably capable of being re-used. The shape of the tool is therefore preferably selected to be such that it is capable of being removed from the interior of the cooled glass body without causing destruction. In this case the tool preferably consists at least in part of a mineral substance, metal, porcelain or a high-temperature-resistant glass body.

In a further preferred embodiment of the present invention the treatment area is acted upon two-dimensionally with a force by means of at least one further tool preferably in a linear manner and particularly preferably in a point-wise manner or by a combination of these variants of force introduction. This has the advantage that high forces are capable of being applied in a defined manner for example to the first texture which is made step-shaped at least in part and/or spiral-shaped at least in part. It is preferable for force to be applied to regions of the first texture which with respect to the plane of the outer edge are inclined at an angle which is more acute as compared with the orientation of the other regions of the inner texture. This has the advantage that the further tool is capable of being positioned in a simple manner at the place to be treated.

In a further preferred embodiment of the present invention the application of force to the treatment area is carried out manually or in an automated manner. This has the advantage that in the case of mass production for example a plurality of further tools designed in the manner of chisels is capable of being controlled mechanically or in the case of small-scale mass production or one-off production the further tool is handled by the operator. In this case it is possible for the operator to operate electrically, pneumatically, hydraulically and/or mechanically assisted tools.

In a further preferred embodiment of the present invention, cracks and break-outs are produced in the glass body by the co-operation of the further tool with the glass body, in which case the cracks and break-outs preferably extend at most to an outer region of the main body which has an external texture. In this case the outer region can be regarded as an outer surface, and the cracks and break-outs preferably do not extend through it or only extend to immediately in front of it. This has the advantage that a laceration of the surface or the outer texture is prevented, as a result of which the outer surface exists in a substantially comparable configuration in tactile and visual terms. Configurations are also possible, however, in which lacerations or cracks and break-outs are provided which extend as far as the surface or through the surface.

In a further preferred embodiment of the present invention the outer texture has regions formed in a similar manner at least in part and preferably has flat portions and/or spherical portions. In this case spherical portions are to be understood as being curved surface regions shaped in a continuous and discontinuous manner. Examples of this are elliptical shapes, ovoid, corrugated or heart-shaped curves and combinations thereof. It is likewise possible, however, for the outer texture to have flat portions and as a whole to be made diamond-shaped, crystal-shaped, cuboid, or tetrahedral and/or from combinations of these design variants. Combinations of spherical portions and flat portions in one outer texture are also of course possible. This is advantageous since, depending upon demand or market development, any desired shapes of the outer texture of the glass body or of the main body can be produced. The outer surface of the glass body is preferably smooth, but it can likewise be roughened or textured in accordance with the inner surface.

In a further preferred embodiment of the present invention the glass body is formed from tempered glass. This has the advantage that the glass has mechanical stresses in a purposeful manner, as a result of which the breaking strength is increased with respect to mechanical stressing. The treatment of a glass body consisting of tempered glass with the further tool has the advantageous result that a laceration of the glass body as a whole is prevented. The glass used is preferably super-white glass, as a result of which a high degree of photo-conductivity and a neutral colour impression is provided, but the use of acrylic glass is also possible. It is likewise possible, however, for the glass to be milky, to enclose particles of metal or other particles, to be coloured or to have a combination of these properties. After the tempering of the glass the outer face of the glass body is preferably finely ground and polished with an optical surface quality. Corresponding treatment is likewise possible in the case of further glass elements or glass bodies arranged on the glass body. If for example a glass substructure is glued to the glass body, then the faces to be glued preferably have to be ground off, polished and provided with a high-quality glass join By means of subsequent fine grinding and polishing at the outer points of the adhesive join the body is capable of being prepared in such a way that it may be recognized as being a one-piece, compact and solid glass body.

The present invention likewise relates to a glass body for the refraction of light, the glass body being transparent and the glass body having an inner surface for differentiation from an interior space. According to the invention a glass body of this type has an inner surface with a texture which is formed at least in part in a random manner. This has the advantage that a plurality of differently formed shapes of the inner surface are present, as a result of which sharp edges, bulges and/or break-outs for example are provided at individual locations. An interesting and unique overall impression results from the multiplicity and the large number of details.

The invention likewise relates to a lighting apparatus for producing light effects, in which the lighting apparatus has a glass body for the refraction of light and the glass body is transparent and has an inner surface for differentiation from an interior space and the texture of the inner surface is formed at least in part in a random manner. In addition, the lighting apparatus has a lighting means preferably for generating light for the light effects, the lighting means being arranged in or on a further body different from the glass body for positioning with respect to the glass body. A lighting apparatus of this type is advantageous since light generated by a lighting device is refracted differently on the inner surface of the glass body formed at least in part in a random manner and thus illuminates in a multiplicity of different colours. In addition, the texture of the inner surface is illuminated by the light in such a way that it is accentuated at least in part, i.e. is detectable from outside the glass body. Furthermore, it is likewise possible, however, for the lighting means to be provided in or on the glass body.

In a further preferred embodiment of the present invention the main body and the further body are capable of being coupled to each other. This has the advantage that the lighting means is capable of being adjusted or positioned in a defined manner.

In a further preferred embodiment of the present invention the lighting means is interchangeable. This has the advantage that a new or different lighting means can be provided if for example a greater illuminating power, a different light colour or the replacement of a defective lighting means is required.

Further devices, which are capable of being coupled for example to the lighting device, are a dimmer, a control unit for actuating a flashing light or a change in colour a time-controlled wake-up function or the like. It should be further pointed out that means for transmitting energy can be provided in the further body, i.e. for example current cables for connecting the lighting device to a mains system and/or receiving means for receiving accumulators for operating the lighting apparatus in a manner independent of the mains system. In addition, it is possible for the lighting apparatus to be capable of being supplied with current by way of the electrical system of a vehicle.

At this point it should be pointed out once more that all the features disclosed in the application documents further develop in an advantageous manner, individually or in combination with one another, generic production methods or production methods, glass bodies and lighting apparatus known from the prior art. Further advantages, aims and properties of the present invention are explained with reference to the following description of accompanying drawings, in which glass bodies are illustrated by way of example. In this case, components of the glass bodies which in the figures correspond at least substantially in their function can be designated with the same reference number, as it is not necessary for these components to be numbered and explained in all the figures.

Further advantageous embodiments may be seen in the accompanying drawings. In the drawings

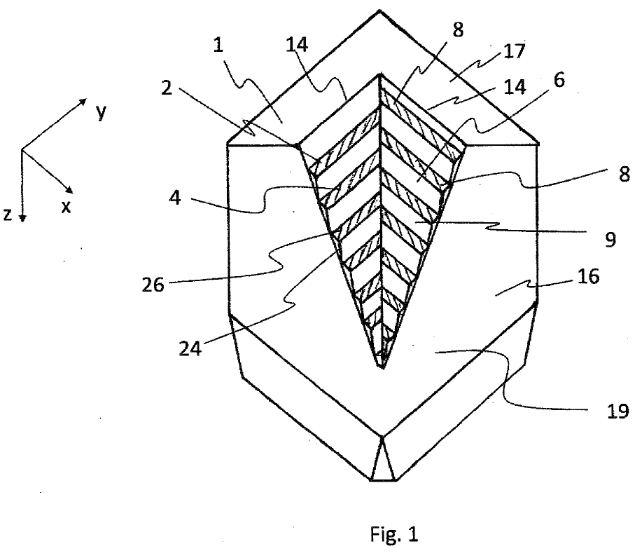

FIG. 1 is a three-dimensional cross-sectional illustration of a glass body according to the invention in an unfinished state;

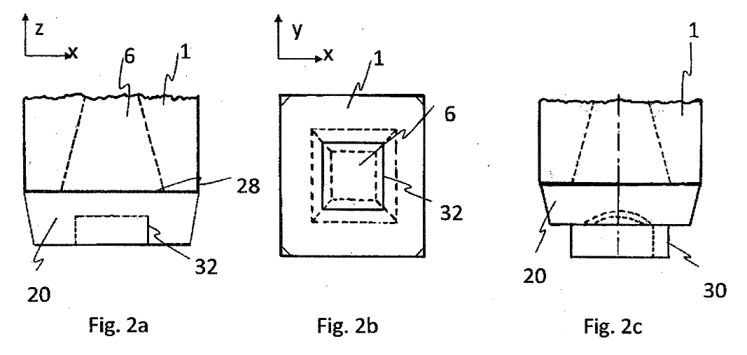

FIG. 2a is a two-dimensional illustration of components of the lighting device coupled to one another;

FIG. 2b is a two-dimensional illustration of a bottom view of the components shown in FIG. 2a;

FIG. 2c is a further two-dimensional illustration of components of the lighting device coupled to one another;

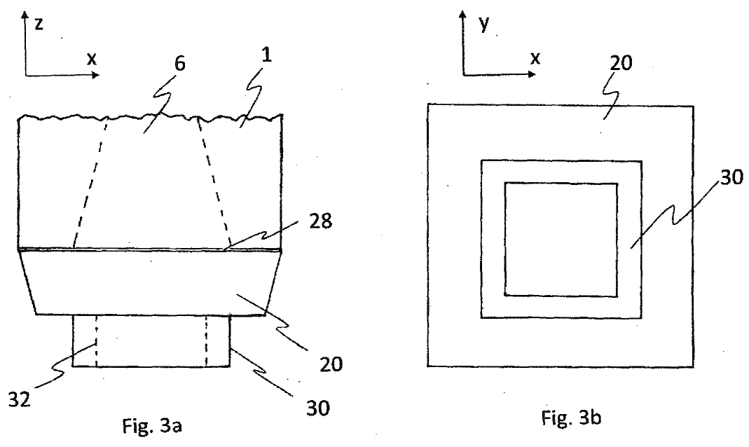

FIG. 3a is a further two-dimensional illustration of a plurality of components of the lighting apparatus;

FIG. 3b is a two-dimensional illustration of a bottom view of the components shown in FIG. 3a;

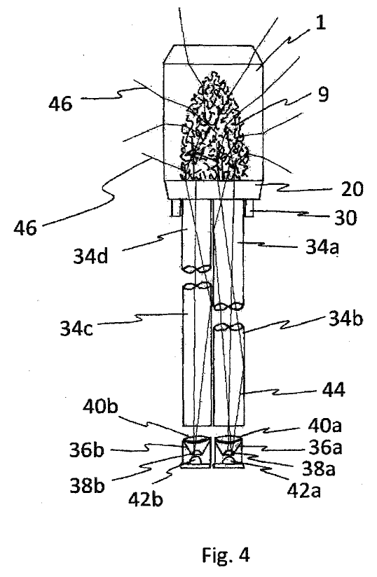

FIG. 4 is a two-dimensional illustration of a side view of the apparatus according to the invention;

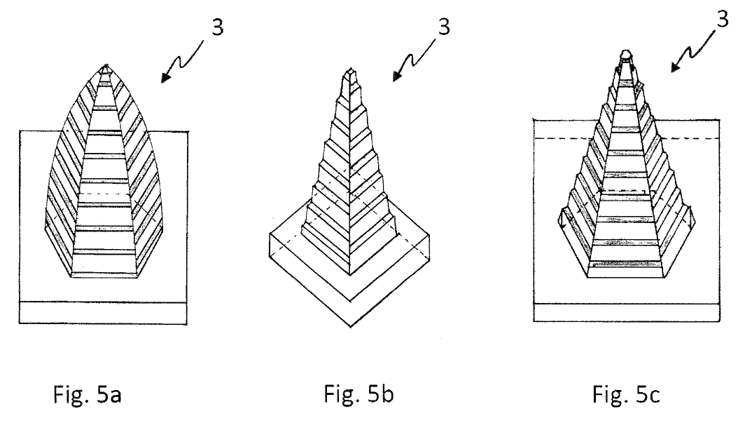

FIG. 5a is a three-dimensional illustration of a first embodiment of the tool;

FIG. 5b is a three-dimensional illustration of a further embodiment of the tool;

FIG. 5c is a three-dimensional illustration of a yet further embodiment by way of example;

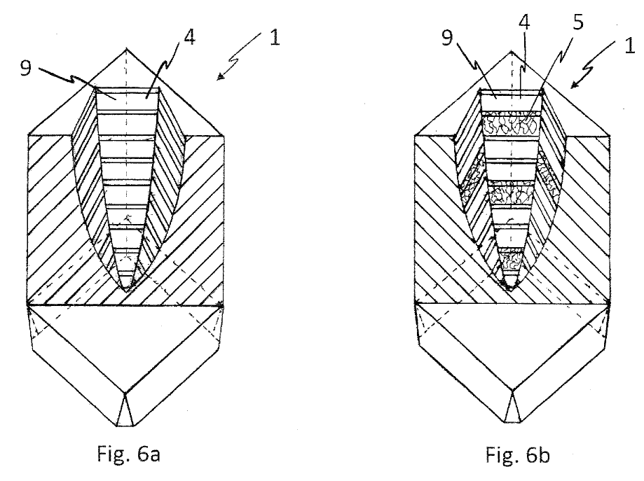

FIG. 6a is a three-dimensional illustration of a glass body before the formation of the second texture;

FIG. 6b is a three-dimensional illustration of a glass body after the formation of at least part of the second texture;

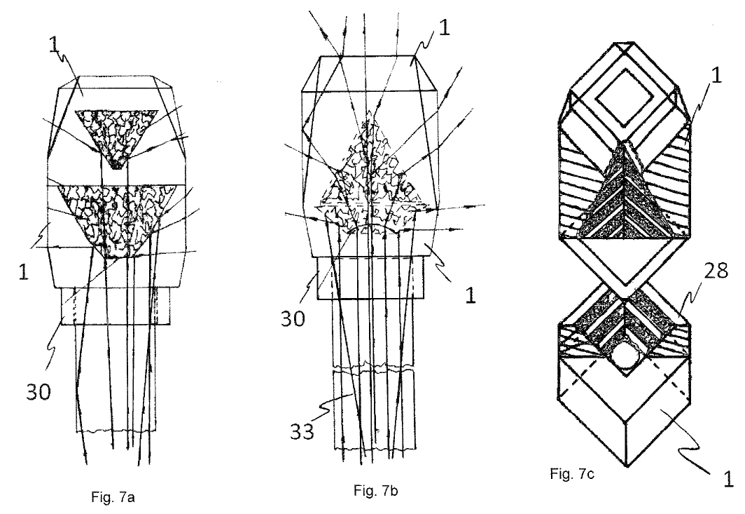

FIG. 7a is a three-dimensional illustration of a first combined embodiment;

FIG. 7b is a three-dimensional illustration of a second combined embodiment;

FIG. 7c is a three-dimensional illustration of a further combined embodiment, and

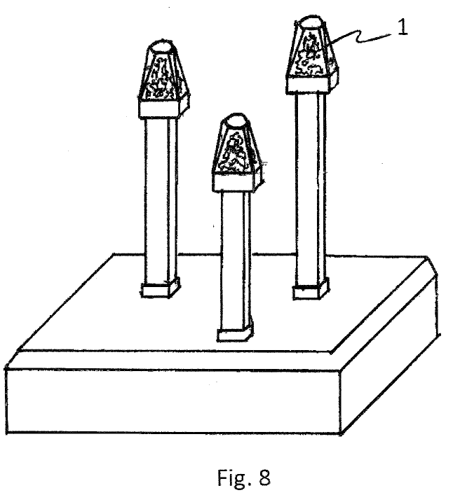

FIG. 8 shows an example of a multiple arrangement.

FIG. 1 shows a glass body 1 in an annular mould 2, the glass body being made cuboid to polygonal and preferably with faces ground on the outside. The unfinished state occurs after the hardening of the glass introduced into a suitable mould and after the removal of the tool. The glass body 1 forms a polygonal-pyramidal hollow body which is made tetragonal to octagonal for example. The tool is first enclosed by the liquid glass, as a result of which the glass forms an impression or a counter mould with respect to the tool on cooling. This counter mould represents a first texture 4 of the glass body which can likewise be referred to as an anti-crystal. The first texture 4 forms a step-shaped treatment region 8 which extends in a tapered manner into the interior of the glass body 1 in the Z-direction. The treatment region 8 and the first texture 4 are formed on the inner surface 9 of the glass body 1 and have slightly inclined surface portions 24 and sharply inclined surface portions 26 provided in an alternating sequence. In this case the surface portions 24 and 26 are orientated or inclined with respect to an outer edge 14 or a plane which is formed by the outer edges 14.

In this case the outer texture 16 of the glass body 1 is made uniform or with smooth surfaces or curve elements, it likewise being possible for the outer texture 16 to be textured in accordance with the nature of the first texture or a second texture. In the base region 17 the glass body 1 has a contact face by which it is capable of being brought into contact with further components. From the base region 17 to the head region 19 the ratio between the space demanded by the glass body 1 and the space demanded by the interior space 6 preferably drops steadily, i.e. the cross-sectional face of the interior space preferably drops with the height of the glass body. In this case the base region 17 has a rectangular base area in which a rectangular break-out is likewise provided. In this illustration the base region 17 thus extends in the width direction x and in the depth direction y, but it is likewise possible for the base region 17 to have a curved, polygonal base shape, i.e. a base shape with more or less than four angles, or contains portions curved at least in part. Similar remarks like-wise apply to the base surface of the break-out or the base surface of the interior space 6. By means of a further tool which can be brought into contact with the glass body 1 on the sharply inclined surface portions 26, it is possible for pieces to be knocked, broken, chiselled and/or hacked off from the glass body, as a result of which the second texture (not shown) is formed which is formed in a random manner at least in part.

FIG. 2 is a two-dimensional sectional illustration of a glass body 1 on which a further body 20 is arranged. In this case the further body 20 is coupled to the glass body 1 by means of a plug-in connection (with positive or with friction locking), a magnetic connection or a material connection for example. It is particularly preferred for the further body 20 to be joined to the glass body 1 by means of an adhesive join at the connection point 28 or in the adhesion joint 28. The area indicated with broken lines in the glass body 1 in FIG. 2a represents the interior space 6 of the glass body 1. The lower region of the further body 20 has a recess 32 which in the embodiment illustrated forms an internal square for the introduction of a lighting means, in particular a light guide strip or a plurality of light guide strips. The light is capable of being guided by means of the light guide strips from the light source to the radiation body 1 in order to generate light effects. The light source can be configured in such a way as to permit the radiation of differently coloured light. It is possible for example for LEDs of different colour and/or power to be provided, which simultaneously emit light in different light guide strips. In this way the illuminant or the lighting device in combination with an LED light source for example offers a multiplicity of possibilities of variation which can be formed in accordance with the type, size, nature of the light guide strips (for example with a square cross-section or a round cross-section), the design and the lighting power. An advantage which results from the use of LEDs for example is that no heat generation or only a relatively low heat generation occurs, thus resulting in only minor heat losses. The light guide strips are capable of being coupled physically to the lighting device for example, preferably with positive locking. The recess 32 in the further body 20 is preferably provided centrally below the pyramidal recess or the interior space 6 respectively The further body 20 preferably consists of the same material as the glass body 1 and/or preferably at least in part of one or more materials from the group comprising metal, wood, plastics material, carbon fibre and ceramics FIG. 2b is a bottom view of the arrangement of components shown in FIG. 2a, in which the line designated by the reference number 32 represents the point from which the recess 32 extends into the interior of the further body 20. The interior space 6, the edges of which projected onto the underside of the further body 20 are formed symmetrically to the base form pre-determined by the break-out 32, are represented by the broken lines.

FIG. 2c shows a further two-dimensional embodiment of components of the lighting device coupled to one another, in which case a lens arrangement or a convex surface is capable of being provided in or on the further body 20. It is likewise possible for a concave shaping of the further body 20 to be provided.

FIG. 3a is a further two-dimensional view of an arrangement of components in which the glass body 1 is shown only in part. In this illustration the interior space 6 is again indicated in broken lines at least in part, the reference number 28 designating the adhesion joint between the glass body 1 and the further body 20 and an attachment collar 30 being provided in order to introduce the light stick or the light sticks in the interior of the further body 20. The attachment collar 30 preferably has a planar or a concave irradiation area.

The further body 20 and the attachment collar 30 are in turn illustrated in a plan view in FIG. 3b. In this case the attachment collar 30 is likewise made square and has a receiving area for the introduction of the light guide strip or the light guide strips. It is likewise true of the attachment collar 30 that it can be made spherical and/or planar. It is preferable for the attachment collar 30 to consist of the same material as the further body 20, but it is likewise possible for it to consist of a different material or of a combination of different materials, such as for example metal, ceramics, wood, or plastics material.

As compared with the further body 20 illustrated in FIG. 2a, in the illustration shown in FIG. 3a the lighting means is at a greater distance from the glass body 1 or the anti-crystal. In this case the attachment collar 30 can be made integrally in one piece with the further body 20, or it can be joined thereto in a detachable manner or coupled thereto in a detachable manner.

FIG. 4 is a two-dimensional illustration of a side view of an embodiment of the apparatus according to the invention. In this case the apparatus has a glass body 1 which preferably has prismatic faces. The internal surface 9 of the glass body 1 is formed in a random manner and preferably has reflective faces like conchoidal fractures and light-refraction areas. As described above, the internal surface 9 of the glass body 1 formed in a random manner results from the breaking-out or the knocking-out of pieces of glass from the glass body 1. In addition, a further body 20, which forms a glass flange, is arranged or formed on the glass body 1. A stop collar 30, by way of which the entire body is capable of being coupled to the light source or a casing of the light source for example, is arranged in turn on the glass flange 20. Light beams 44 are preferably conducted to the glass body 1 or to the inner surface 9 of the glass body 1 by means of light guide strips 34a, 34b, 34c, 34d (for example Superwhite of the firm Schott—Lighting Components). The light beams 44 are emitted by lighting means 42a, 42b which are preferably designed in the form of an LED or a plurality of LEDs 42a, 42b, preferably an arrangement of 4, 5 or 6, with at least 300 mA, and in a particularly preferred manner in the form of LEDs 42a, 42b with at least 700 mA. The light beams 44 emitted by the LEDs 42a, 42b pass by way of a first lens 38a, 38b into a reflector or into a plurality of reflectors 36a, 36b and a lens system 40a, 40b capable of being focussed. The light beams are preferably refracted and/or reflected at least in part in the glass body 1 by the internal surface 9 before they emerge from the glass body 1.

Various design variants of the tool which is used for producing the first internal texture of the glass body are illustrated in FIGS. 5a-c. It is evident from these figures that the tool can be produced from straight and/or curved surface elements. In addition, it may be seen that the shape of the main body can be made any way desired, but preferably triangular, square, pentagonal, hexagonal, heptagonal, octagonal, polygonal or can be curved at least in part.

FIG. 6a shows a glass body 1 with an internal surface 9 which has the first texture 4 completely. An inner surface 9—treated at least in part—of the main body 1 shown in FIG. 6a is illustrated in FIG. 6b. In this case it is evident that a complete treatment or transfer of the first texture into the second texture 5 is not necessary, i.e. a glass body 1 according to the invention is also capable of being produced by the treatment of individual regions of the first texture. The second texture 5 is preferably shaped like a conchoidal fracture Combined design variants are illustrated in FIGS. 7a-c. First of all, as shown in FIG. 7a for example, two glass bodies 1 of the same orientation are capable of being arranged one above the other. As shown in FIG. 7b two glass bodies 1 orientated differently are joined to each other. In this case a different orientation describes a configuration in which the pyramidally extending interior space of one glass body extends in a different direction from the pyramidal interior space of the further glass body or glass bodies. In FIG. 7c the glass bodies of the embodiment shown in FIG. 7b are illustrated in a position at a distance from each other. The two glass bodies 1 can be glued to each other by way of the connection point 28 for example.

A multiple arrangement of the glass bodies 1 is illustrated in FIG. 8. Further bodies 2, with which the light guide bodies 33 are in contact, are arranged on the glass bodies 1 in each case. In this case a light guide body 33 can be used for receiving individual light guide strips 34 a-d or a plurality of light guide strips 34 a-d (not shown). The light guide bodies 33 are in contact with a casing 41 of a light source or a plurality of light sources, at least part of the electrical system required being arranged in said casing 41.

All the features disclosed in the application documents are claimed as being essential to the invention, insofar as they are novel either individually or in combination as compared with the prior art.

### LIST OF REFERENCES

1 glass body
2 blank
4 first texture
5 second texture
6 interior space
8 treatment area
9 inner surface
12 contact area
14 outer edge
16 outer texture
17 base region
19 head region
20 further body
24 slightly inclined surface portion
26 sharply inclined surface portion
28 connection point
30 attachment collar
32 inner receiving region of the further body
33 light guide body
34a, 34b, 34c, 34d light guide strip
36a, 36b reflector
38a, 38b first lens
40a, 40b lens system
41 casing
42a, 42b lighting means
44 supplied light beams
46 refracted and/or reflected light beams
y depth
x width
z height

1. A method of producing a transparent glass body which is textured at least on the inside, comprising the steps:
producing the glass body in order to prepare a blank to be further treated,
producing a first defined texture of an interior space of the glass body in order to form a treatment area, and
treating the treatment area in order to enlarge the interior space of the glass body,
wherein the treatment of the treatment area results in a second texture formed in a random manner at least in part.

2. The method according to claim 1, wherein during the production of the glass body the interior space is formed by a tool which is enclosed at least in part by the material forming the glass body.

3. The method according to claim 1, wherein the tool has a defined shape by which the material in a contact region forms the first texture which substantially corresponds to the shape of the tool.

4. The method according to claim 3, wherein the first texture is formed in such a way that it is largest in surface area in the plane of an outer edge of the glass body and is orientated in its extension direction in an angular range of less than or equal to 90° with respect to the plane.

5. The method according to claim 1, wherein the first texture is preferably made step-shaped at least in part and/or is preferably made spiral-shaped at least in part.

6. The method according to claim 1, wherein after the glass body has been produced the tool is removed from the region of the glass body.

7. The method according to claim 1, wherein the treatment area is acted upon two-dimensionally with a force of at least one further tool preferably in a linear manner and particularly preferably in a point-wise manner or by a combination of these variants of force introduction.

8. The method according to claim 7, wherein the application of force upon the treatment area is carried out manually or in an automated manner.

9. The method according to claim 7, wherein cracks and break-outs are produced in the glass body by the co-operation of the further tool with the glass body, wherein the cracks and break-outs preferably extend at most to an outer region of the main body which has an external texture.

10. The method according to claim 9, wherein the outer texture has regions formed in a similar manner at least in part and preferably has flat portions and/or spherical portions.

11. The method according to claim 1, wherein the glass body is formed from tempered glass.

12. A glass body for the refraction of light, wherein the glass body is transparent and wherein the glass body has an inner surface which encloses an interior space, wherein the texture of the inner surface is made at least in part in a random manner.

13. A lighting apparatus for producing light effects, with a glass body according to claim 12 and with a light source for generating light for the light effects, wherein the light source is arranged in or on a further body different from the main body for positioning with respect to the main body.

14. The apparatus according to claim 13, wherein the main body and the further body are capable of being coupled to each other.

15. The apparatus according to claim 13, wherein the light source is interchangeable.
